(19) United States
(12) Patent Application Publication
(10) Pub. No.: US 2024/0424396 A1
(43) Pub. Date: Dec. 26, 2024

(54) VISUAL FOCUS OVERLAY

(71) Applicant: Toyota Research Institute, Inc., Los Altos, CA (US)

(72) Inventors: Shawn R Manuel, Mountain View, CA (US); John Subosits, Mountain View, CA (US); Yun Jung Lee, Mountain View, CA (US); Avinash Balachandran, Sunnyvale, CA (US)

(73) Assignees: Toyota Research Institute, Inc., Los Altos, CA (US); Toyota Jidosha Kabushiki Kaisha, Toyota-shi (JP)

(21) Appl. No.: 18/339,495

(22) Filed: Jun. 22, 2023

(51) Int. Cl. A63F 13/5375; A63F 13/803

(52) U.S. Cl. CPC A63F 13/5375; A63F 13/803

(57) ABSTRACT

Systems, methods, and other embodiments described herein relate to assisting a user of a vehicle driving the vehicle along a track. In one embodiment, a method includes developing a driving model for the vehicle travelling on the track. The method includes determining a current state of the vehicle along the track and outputting eye direction instruction for the user of the vehicle based on the driving model and the current state of the vehicle.

### FIELD

The subject matter described herein relates in general to assisting a user of a vehicle driving the vehicle along a track.

### BACKGROUND

Driving simulation systems are limited to simulating vehicle dynamics in response to a vehicle user's steering and throttle input. Current driving simulation systems lack tools based on artificial intelligence (AI) techniques to assist in improving the driving skills of the vehicle user. In particular, current driving simulation systems that assist users learning to drive racecars lack tools based on AI techniques.

### SUMMARY

This section generally summarizes the disclosure and is not a comprehensive explanation of its full scope or all its features.

In one embodiment, a method for assisting a user of a vehicle driving the vehicle along a track is disclosed. The method includes developing a driving model for the vehicle travelling on a track, determining a current state of the vehicle along the track, and outputting eye direction instruction for a user of the vehicle based on the driving model and the current state of the vehicle.

In another embodiment, a system for assisting a user of a vehicle driving the vehicle along a track is disclosed. The system includes a processor and a memory in communication with the processor. The memory stores machine-readable instructions that, when executed by the processor, cause the processor to develop a driving model for a vehicle travelling on a track, determine a current state of the vehicle along the track, and output eye direction instruction for a user of the vehicle based on the driving model and the current state of the vehicle.

In another embodiment, a non-transitory computer-readable medium for assisting a user of a vehicle driving the vehicle along a track and including instructions that, when executed by a processor, cause the processor to perform one or more functions, is disclosed. The instructions include instructions to develop a driving model for a vehicle travelling on a track, determine a current state of the vehicle along the track, and output eye direction instruction for a user of the vehicle based on the driving model and the current state of the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an example of a driving simulation system incorporating a visual focus overlay (VFO) system.

FIG. 2 is an example of a vehicle incorporating a VFO system.

FIG. 3 illustrates a block diagram of a vehicle incorporating the VFO system.

FIG. 4 is a more detailed block diagram of the VFO system of FIGS. 1-3.

FIG. 5 is an example of a method for assisting a user of a vehicle driving the vehicle along a track.

FIG. 6 is an example of assisting a user of a vehicle driving the vehicle along a track.

### DETAILED DESCRIPTION

Systems, methods, and other embodiments associated with assisting a user of a vehicle (or vehicle driver) driving the vehicle along a track, are disclosed. As an example, the vehicle may be a racecar travelling on a racetrack. As such, the systems, methods, and other embodiments may assist a user or operator of a racecar driving the racecar along a racetrack.

Becoming an expert racecar driver is a challenging task that often takes years of practice in a driving simulation system and on a track. As an example, a novice driver may experiment and test many different techniques (e.g., steering control, acceleration control, braking control, positioning along a track, and timing) before identifying optimal driving strategies. The novice driver may also apply a trial-and-error method to determine where to focus their attention and their eyes for optimal vehicle control.

Accordingly, in one embodiment, the disclosed approach is visual focus overlay (VFO) system that assists a user of a vehicle driving the vehicle along a track by providing artificial intelligence (AI) based training feedback to the user by indicating to the user where in the environment surrounding the vehicle to focus their eyes based on the current state of the vehicle. In one embodiment, the VFO system may be part of a driving simulation system with a simulated vehicle and a simulated track. In another embodiment, the VFO system may be part of an actual vehicle. The VFO system may include a display screen capable of displaying the environment surrounding the vehicle. The VFO system may further include a windshield. The display screen and/or the windshield may be capable of highlighting portions of the environment surrounding the vehicle using as an example, a visual overlay on the surface of the display screen and/or the windshield.

The VFO system develops an optimal driving model using AI and/or machine learning techniques. The optimal driving model is a predictive model that maps the current state of the vehicle and track information to a location and/or an object that an expert driver would focus their eyes on. The VFO system may develop the optimal driving model using imitation learning based on observing and imitating expert drivers and/or reinforcement learning based on a reward system in response to carrying out various actions.

The VFO system may then determine the current state of the vehicle. The current state of the vehicle may include a location of the vehicle along the track, proximity of the vehicle to surrounding objects, an orientation of the vehicle, and/or a speed of the vehicle. In the embodiment where the VFO system is part of a driving simulation system, the current state of the simulated vehicle may be derived from the driving simulation system. In the embodiment where the VFO system is part of an actual vehicle, the VFO system may utilize any suitable sensors and/or vehicle systems to determine the current state of the vehicle. The VFO system may then apply the current state of the vehicle (simulated or actual) as an input to the optimal driving model and predict a location where an expert driver would focus their eyes based on the current state of the vehicle. In the embodiment where the VFO system includes a display screen that displays the environment surrounding the vehicle, the VFO system may identify the location that the expert driver would focus their eyes in the environment and the display screen would highlight the location using, as an example, a higher brightness level at the location and a lower brightness level at the surrounding areas. In the embodiment where the VFO system includes a windshield with the capability to highlight portions of the windshield so as to indicate to the user that the user focus on the environment visible through the highlighted portions of the windshield, the windshield may keep the location that the expert driver would focus on transparent and tint or darken the surrounding areas.

It will be appreciated that arrangements described herein can provide numerous benefits, including one or more of the benefits mentioned herein. For example, arrangements described herein significantly reduce the training time of a vehicle driver as the vehicle driver learns from the AI-based driving model in place of relying on human-based trial and error methods. More specifically, the arrangements described herein are suitable for training racecar drivers driving on a racetrack. Arrangements disclosed herein determine the location that the vehicle driver should focus their eyes in real time based on the location, orientation, speed of the vehicle as well as the surroundings of the vehicle. Arrangements described herein may include a display screen with a visual overlay to indicate the location where the vehicle driver should focus their eyes. Arrangements described herein may include a window of a vehicle capable of outputting a visual overlay or adjusting the visibility of the window to highlight a location in the surrounding environment. Arrangements described herein apply to limit the rate at which the location changes and is updated based on human ability. Arrangements described herein may determine the location that the user should focus on based on the position of the user's head. Arrangements described herein may be suitable for use in a simulated environment and/or a real-life environment. Arrangements described herein may assist a vehicle driver in achieving goals such as a shorter track completion time, optimal race line selection, and/or lowest fuel consumption.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

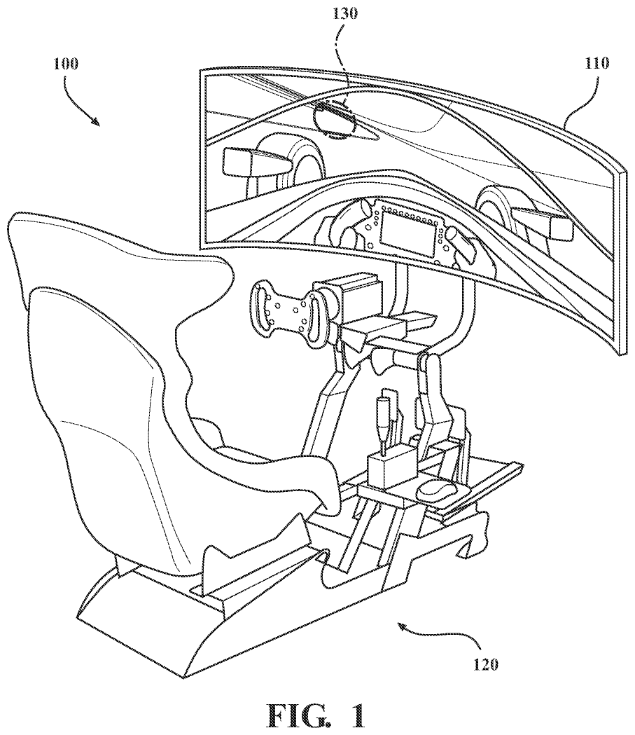

Referring to FIG. 1, an example of a driving simulation system 120 incorporating a visual focus overlay (VFO) system 100 is shown. The VFO system 100 can include various elements, which can be communicatively linked in any suitable form. As an example, the elements can be connected, as shown in FIG. 1. Some of the possible elements of the VFO system 100 are shown in FIG. 1 and will now be described. It will be understood that it is not necessary for the VFO system 100 to have all of the elements shown in FIG. 1 or described herein. The VFO system 100 can have any combination of the various elements shown in FIG. 1. Further, the VFO system 100 can have additional elements to those shown in FIG. 1. In some arrangements, the VFO system 100 may not include one or more of the elements shown in FIG. 1. Further, it will be understood that one or more of these elements can be physically separated by large distances.

The driving simulation system 120 may include a simulated vehicle in a simulated environment. The VFO system 100 may include a display screen 110. The display screen 110 is capable of displaying a portion of the simulated environment external to the simulated vehicle that would be visible to a user of the simulated vehicle. As an example, the display screen 110 may display a view of the simulated environment that would be visible through the front windshield of the simulated vehicle. Additionally and/or alternatively, the display screen 110 may display a view of the environment that would be visible through the side windows and/or through the back windshield of the simulated vehicle. The simulated environment may be based on a real environment and/or a fictional environment.

In one embodiment, the VFO system 100 may be part of an actual vehicle. The vehicle may include a display screen 110. The display screen 110 is capable of displaying a portion of the environment external to a vehicle that may be visible to a user of the vehicle. In other words, the display screen 110 may output a view of the environment visible to the user through a window of the vehicle. As an example, the display screen 110 may output a view of the environment visible through the front windshield of the vehicle. Additionally and/or alternatively, the display screen 110 may output a view of the environment visible through the side windows and/or through the back windshield of the vehicle.

The display screen 110 is capable of outputting a visual overlay on top of the environment being shown on the display screen 110. The display screen 110 is capable of arranging the visual overlay on top of the environment being shown on the display screen 110 so as to emphasize a portion of the environment and/or the display screen 110. As an example, the display screen 110 can emphasize or draw attention to a portion 130 of the environment displayed on the display screen 110 by increasing the brightness in the portion relative to the remaining areas of the display screen 110. As another example, the display screen 110 may use arrows, circles 130, and/or any suitable shape to draw attention to a portion 130 of the environment displayed on the display screen 110. As another example, the display screen 110 may keep the portion of interest 130 in focus and blur the remaining areas of the display screen 110.

The VFO system 100 may include sensors that are capable of monitoring the position of the user's head and/or eyes. The sensors can include a camera that can monitor the user, detect the position of the user's head, and/or track the position of the user's eyes.

In an embodiment where the VFO system 100 may be a part of a vehicle, the display screen 110 may be located inside the vehicle, e.g., on the dashboard. The sensors may be located at any suitable positions in the driving simulation system 120 or in the vehicle.

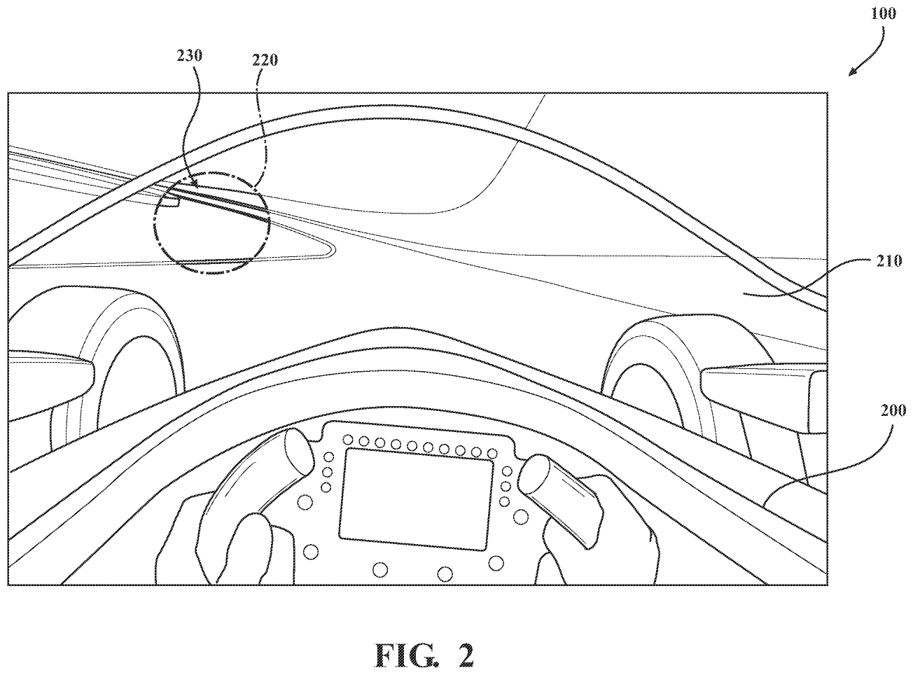

Referring to FIG. 2, an example of a vehicle 200 incorporating a VFO system 100 is shown. In one embodiment, the VFO system 100 may include a window 210 of the vehicle 200. The window 210 can be transparent such that the user of the vehicle 200 can view the environment external to the vehicle 200. As such, the VFO system 100 may include a windshield of the vehicle 200 such as the front windshield or the back windshield. Further, the VFO system 100 may include side windows of the vehicle 200. A window 210 of a vehicle 200 is being used as a general term to refer to the front windshield, the side windows, and the back windshield.

The window 210 is capable of outputting a visual overlay on top of the transparent surface such that the visual overlay is visible to the user. The window 210 is capable of arranging the visual overlay on the window so as to emphasize a portion of the environment visible through the window 210. As an example, the window 210 can emphasize or draw attention to a portion of the environment increasing the brightness in the portion relative to the remaining areas of the window 210. As another example, the window 210 may use arrows, circles 220, and/or any suitable shape to draw attention to a portion 230 of the environment visible through the window 210. As another example, the window 210 may keep the portion of interest 230 in focus and blur the remaining areas of the window 210.

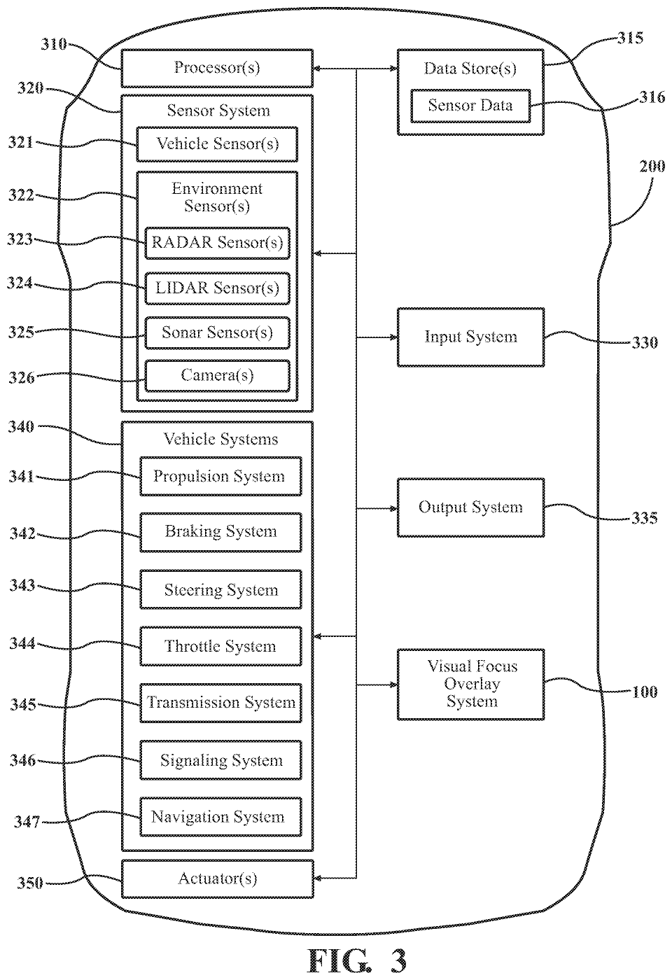

Referring to FIG. 3, a block diagram of a vehicle 200 incorporating the VFO system 100 is illustrated. The vehicle 200 includes various elements. It will be understood that in various embodiments, it may not be necessary for the vehicle 200 to have all of the elements shown in FIG. 3. The vehicle 200 can have any combination of the various elements shown in FIG. 3. Further, the vehicle 200 can have additional elements to those shown in FIG. 3. In some arrangements, the vehicle 200 may be implemented without one or more of the elements shown in FIG. 3. While the various elements are shown as being located within the vehicle 200 in FIG. 3, it will be understood that one or more of these elements can be located external to the vehicle 200. Further, the elements shown may be physically separated by large distances.

Some of the possible elements of the vehicle 200 are shown in FIG. 3 and will be described along with subsequent figures. However, a description of many of the elements in FIG. 3 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 3, the vehicle 200 includes the VFO system 100 that is implemented to perform methods and other functions as disclosed herein relating to assisting a user of a vehicle driving the vehicle along a track. As an example, the VFO system 100, in various embodiments, may be implemented partially within the vehicle 200 and may further exchange communications with additional aspects of the VFO system 100 that are remote from the vehicle 200 in support of the disclosed functions. Thus, while FIG. 3 generally illustrates the VFO system 100 as being self-contained, in various embodiments, the VFO system 100 may be implemented within multiple separate devices, some of which may be remote from the vehicle 200.

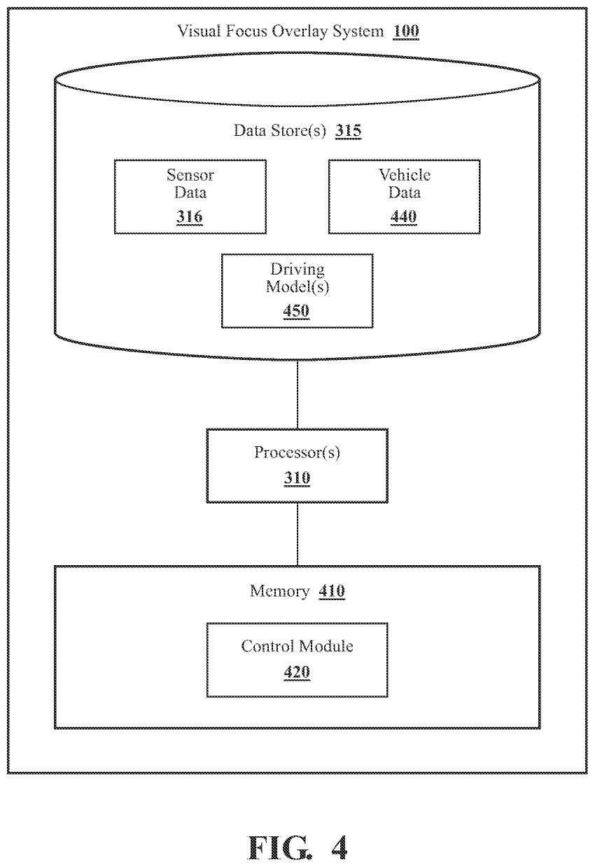

With reference to FIG. 4, a block diagram of the VFO system 100 is shown. The VFO system 100 may include a processor(s) 310. Accordingly, the processor(s) 310 may be a part of the VFO system 100, or the VFO system 100 may access the processor(s) 310 through a data bus or another communication pathway. In one or more embodiments, the processor(s) 310 is an application-specific integrated circuit that may be configured to implement functions associated with a control module 420. More generally, in one or more aspects, the processor(s) 310 is an electronic processor, such as a microprocessor, that can perform various functions as described herein when loading the control module 420 and executing encoded functions associated therewith.

The VFO system 100 may include a memory 410 that stores the control module 420.

The memory 410 may be a random-access memory (RAM), read-only memory (ROM), a hard disk drive, a flash memory, or other suitable memory for storing the control module 420. As such, the memory stores machine-readable instructions. The control module 420 is, for example, a set of computer-readable instructions that, when executed by the processor(s) 310, cause the processor(s) 310 to perform the various functions disclosed herein. While, in one or more embodiments, the control module 420 is a set of instructions embodied in the memory 410, in further aspects, the control module 420 includes hardware, such as processing components (e.g., controllers), circuits, etc. for independently performing one or more of the noted functions.

The VFO system 100 may include a data store(s) 315 for storing one or more types of data. Accordingly, the data store(s) 315 may be a part of the VFO system 100, or the VFO system 100 may access the data store(s) 315 through a data bus or another communication pathway. The data store 315 is, in one embodiment, an electronically based data structure for storing information. In at least one approach, the data store 315 is a database that is stored in the memory 410 or another suitable medium, and that is configured with routines that can be executed by the processor(s) 310 for analyzing stored data, providing stored data, organizing stored data, and so on. In either case, in one embodiment, the data store 315 stores data used by the control module 420 in executing various functions. In one embodiment, the data store 315 may be able to store sensor data 316, vehicle data 440, driving model(s) 450 and/or other information that is used by the control module 420.

The data store(s) 315 may include volatile and/or non-volatile memory. Examples of suitable data stores 315 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 315 may be a component of the processor(s) 310, or the data store(s) 315 may be operatively connected to the processor(s) 310 for use thereby. The term “operatively connected” or “in communication with” as used throughout this description, can include direct or indirect connections, including connections without direct physical contact.

In one or more arrangements, the data store(s) 315 can include sensor data 316. The sensor data 316 can originate from the sensors that are part of the driving simulation system 120. Additionally and/or alternatively, the sensor data 316 can originate from the sensor system 320 of the vehicle 200. The sensor data 316 can include data from visual sensors and/or any other suitable sensors in the vehicle 200 capable of monitoring the position of the user's head and/or the user's eyes.

In one or more arrangements, the data store(s) 315 can include vehicle data 440. The vehicle data 440 can include a current state of the vehicle 200 along the track. In one embodiment where the VFO system 100 is a part of a driving simulation system 120, the vehicle and the track are in a simulation. As such, the vehicle and/or the track are simulated. In such a case, the vehicle data 440 is based on the current state of the simulated vehicle along the simulated track.

In one embodiment where the VFO system 100 is part of an actual vehicle, the vehicle data 440 can include the current state of the vehicle 200 along the track. Further and in one example, the VFO system 100 may be a part of a vehicle 200 travelling on an actual track. In another example, the VFO system 100 may be a part of a vehicle 200 travelling on a simulated track.

The current state of the vehicle 200, both simulated or actual, may include at least one of a location of the vehicle 200 along the track, proximity of the vehicle 200 to surrounding objects, an orientation of the vehicle 200, or a speed of the vehicle 200. For the driving simulation system, the current state of the vehicle 200 such as the location of the vehicle 200 along the track, the proximity of the vehicle 200 to surrounding objects, the orientation of the vehicle 200, and/or the speed of the vehicle 200 is based on the simulation model(s) being applied. For an actual vehicle 200 on an actual track, the current state of the vehicle 200 may be based on location sensors such as GPS, vehicle sensors associated acceleration and braking, and any suitable environment sensors monitoring the environment around the vehicle 200.

In one or more arrangements, the data store(s) 315 can include driving model(s) 450 for a vehicle 200 travelling on a track. The driving model 450 is a prediction model based on the driving habits and driving style of an expert (or experienced) driver. The driving model 450 predicts a location on a display screen 110 or a window 210 that an expert driver would focus their eyes and/or attention. The driving model 450 predicts the location based on several factors, including the current state of the vehicle 200, additional vehicle information such as vehicle weight, engine power, vehicle weight to engine power, friction of vehicle tires, aerodynamic qualities including down force and drag, track information such as elevation of the track, obstacles and other vehicles along or proximate to the track, the curve of the track, and/or position of the user's head or eyes. The driving model 450 predicts the location based on data associated with driving habits and driving styles of one or more expert drivers. The driving model 450 may predict the location based on a goal of the driving model 450. As an example, the goal of the driving model 450 may be for the user and the vehicle 200 to complete travelling along the track in the shortest possible time. As another example, the goal of the driving model 450 may be for the best fuel consumption as the user and vehicle 200 travel along the track. As another example, the goal of the driving model 450 may be for the user and the vehicle 200 to select and/or remain in the optimal racing line as the vehicle 200 travels along the track.

In one embodiment, the control module 420 may include instructions that, when executed by the processor(s) 310, cause the processor(s) 310 to develop a driving model 450 for a vehicle 200 travelling on a track. The control module 420 may develop the driving model 450 for the track based on at least one of a reinforcement learning process or an imitation and deep learning process.

The control module 420 may develop the driving model(s) 450 for the track based on the reinforcement learning process. In such a case, the control module 420 carries out an action and learns by trial and error using feedback based on each action the control module 420 has taken. As an example, the control module 420 may take the action of selecting a location on the display screen 110 and/or the window 210 for the user to focus on. The control module 420 may then receive feedback on whether the selected location was a good decision or a bad decision and may assign a value to the action. As an example, the control module 420 may assign a positive value or a higher value to a good decision and a negative or lower value to a bad decision. The control module 420 may maintain a cumulative sum of the values associated with the good decisions and the bad decisions based on the actions the control module 420 has taken. The control module 420 may then select one or more driving models 450 having more good decisions than bad decisions.

The control module 420 may develop the driving model(s) 450 for the track based on the imitation and deep learning process. In other words, the control module 420 may develop the driving model(s) 450 for the track based on a combination of the imitation learning process and the deep learning process. For the imitation learning process, the control module 420 may monitor the direction of the expert driver's eyes as the expert driver drives a vehicle 200 along a track. The control module 420 may receive sensor data 316 from the sensors inside the vehicle 200 and determine the direction of the expert driver's eyes based on the received sensor data 316. The control module 420 may associate the current state of the vehicle 200 with the direction of the expert driver's eyes as the expert driver drives along the track. The control module 420 may further determine what the expert driver is looking at based on the direction of expert driver's eyes and may identify the location on the display screen 110 or window 210 associated with what the expert driver is looking at.

The control module 420 may apply the imitation learning process to one or more expert drivers driving various vehicles on various tracks. Using the deep learning process, the control module 420 may learn how to imitate the expert drivers and identify patterns of behavior by the expert drivers so that the control module 420 may develop driving model(s) 450 that are capable of predicting the location 130, 230 on a display screen 110 or on a window 210 that the expert driver will focus on based on the current state of the vehicle 200. As previously mentioned, the driving model(s) 450 may depend on the track in addition to the location and orientation of the vehicle 200 on the track. The control module 420 may develop the driving model(s) 450 based on a combination of reinforcement learning, imitation learning, and deep learning. So as to meet the goal of the shortest completion time for the track, the control module 420 may select driving model(s) 450 in which the vehicle 200 completes the track in less than a predetermined time. So as to meet the goal of lowest fuel consumption, the control module 420 may select driving model(s) 450 in which the fuel consumption of the vehicle 200 is lower than a predetermined value. So as to meet the goal of most suitable racing line and as an example, the control module 420 may select driving models 450 in which the racing line is advantageous for the user, such as the surface of the racing line being the smoothest, the elevation of the racing line being even or sloped to the user's advantage, or the racing line being obstacle-free (including other vehicles).

In one embodiment, the control module 420 may include instructions that, when executed by the processor(s) 310, cause the processor(s) 310 to determine a current state of the vehicle 200 along the track. The current state of the vehicle 200 along the track includes at least one of: a location of the vehicle 200 along the track, proximity of the vehicle 200 to surrounding objects, an orientation of the vehicle 200, or a speed of the vehicle 200. As an example, the control module 420 may determine the location of the vehicle 200 along the track using a Global Positioning System (GPS). More generally, the control module 420 may determine the location of the vehicle 200 by requesting sensor data 316 from any suitable sensors such as GPS, vehicle sensors, and/or environmental sensors such as infrastructure cameras along the track. The control module 420 may determine the proximity of the vehicle 200 to surrounding objects, the orientation of the vehicle 200, and/or the speed of the vehicle 200 based on the sensor data 316. As such, the control module 420 may use sensor data 316 from outside the vehicle 200 such as infrastructure cameras and/or vehicle sensors 321 such as accelerometers, compasses, or magnetic field sensors.

In one embodiment, the control module 420 may include instructions that, when executed by the processor(s) 310, cause the processor(s) 310 to output eye direction instruction for a user of the vehicle 200 based on the driving model(s) 450 and the current state of the vehicle 200. As such, the control module 420 may communicate to the user in what direction the user should focus their eyes and/or attention based on the current state of the vehicle 200. The instructions that, when executed by the processor(s) 310, cause the processor(s) 310 to output eye direction instruction may include highlighting a portion of a display screen 110 for the user to face. As previously mentioned, the display screen 110 may output a view of the environment visible to the user through a window 210 of the vehicle 200. Additionally and/or alternatively, the instructions that, when executed by the processor(s) 310, cause the processor(s) 310 to output eye direction instruction may include highlighting a portion of a window 210 of the vehicle 200 for the user to face.

The control module 420 may predict the direction that an expert driver would focus their eyes based on applying the driving model(s) 450 to the current state of the vehicle 200. The control module 420 may utilize any suitable machine learning techniques in addition to the driving model(s) 450 to predict the direction that the expert driver would focus their eyes based on the current state of the vehicle 200.

In one embodiment, the control module 420 may highlight a portion 130 of a display screen 110 for the user to face based on the direction that the control module 420 predicts that the expert driver would focus on. As an example, the control module 420 would cause the display screen 110 to output a view of the environment outside the vehicle 200. The control module 420 then identifies a location 130 within the view as displayed on the display screen 110 that the user may focus on based on the direction the control module 420 predicts that the expert driver's eyes would face in a similar situation. In a case where the control module 420 identified multiple locations for the user to focus on, the control module 420 may select one from the multiple locations by weighting (or ranking) objects visible at the multiple locations of the display screen 110 or window 210. The control module 420 may weight (or rank) the objects based on any suitable criteria such as safety or speed, and the control module 420 may then select the location where the objects have the highest weight (or rank). The control module 420 may also refresh the location 130, 230 as the location 130, 230 changes at a rate that can be tracked by human eyes. As such, the control module 420 may cause the location 130, 230 to change gradually. As an example, the location 130, 230 may change from a position on the left side of the display screen 110 to a position on the right side of the display screen 110 at a speed that matches the speed at which human eyes are capable of moving from the left side of the environment to the right side of the environment.

The control module 420 may highlight the location 130 on the display screen 110 using any suitable method. As an example, the control module 420 may cause the display screen 110 to increase the brightness of the display screen at the location 130 that the user may focus on and decrease the brightness at the other parts of the display screen. As another example, the control module 420 may cause the display screen 110 to output arrows, circles, or any suitable shape to overlay the view of the environment and highlight the location 130 that the user may focus on. As another example, the control module 420 may cause the display screen 110 to keep the location 130 that the user may focus on in focus and blur the other parts of the display screen 110.

In one embodiment, the control module 420 may highlight a portion 230 of a window 210 of the vehicle 200 for the user to face based on the direction that the control module 420 predicts that the expert driver would focus on. The control module 420 may first select which window the expert driver would be looking through. The control module 420 then identifies a location 230 through the window 210 that the user may focus on based on the direction the control module 420 predicts that the expert driver's eyes would face in a similar situation. The control module 420 may receive the current position of the head of the user from the sensors and may determine the location 230 through the window that the user may focus on based on the direction the control module 420 predicts that the expert driver's eyes would face in a similar situation and the current position of the user's head.

The control module 420 may highlight the location 230 on the window 210 using any suitable method. As an example, the control module 420 may cause the window 210 to remain transparent at the location 230 that the user may focus on and become translucent or opaque at the other parts of the window 210. As another example, the control module 420 may cause the window 210 to output arrows, circles, or any suitable shape to overlay the view of the environment and highlight the location 230 that the user may focus on. As another example, the control module 420 may cause the window 210 to keep the location that the user may focus on clear and blur the other parts of the window 210.

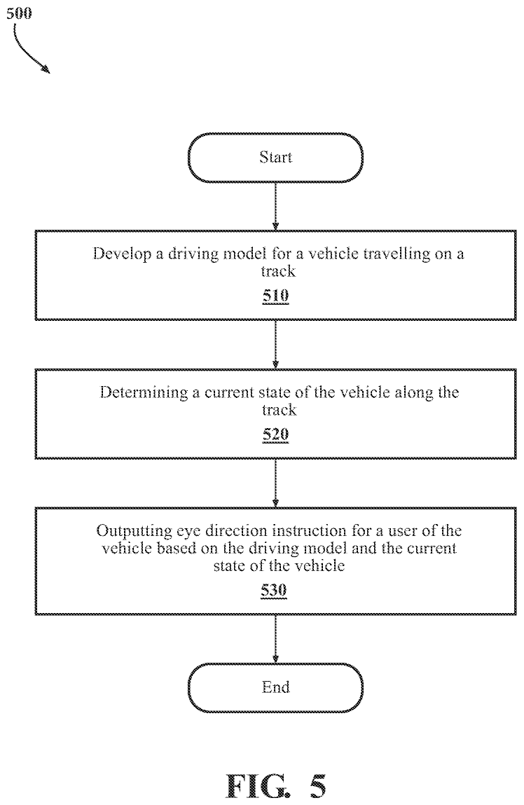

FIG. 5 illustrates a method 500 for assisting a user of a vehicle driving the vehicle along a track. The method 500 will be described from the viewpoint of the driving simulation system 120 of FIG. 1, the vehicle 200 of FIG. 2 and the VFO system 100 of FIGS. 1-4. However, the method 500 may be adapted to be executed in any one of several different situations and not necessarily by the driving simulation system 120 of FIG. 1, the vehicle 200 of FIG. 2 and the VFO system 100 of FIGS. 1-4.

At step 510, the control module 420 may cause the processor(s) 310 to develop a driving model 450 for a vehicle 200 to travel on a track. As previously mentioned, the control module 420 may develop the driving model 450 for the vehicle 200 travelling on the track based on at least one of a reinforcement learning process, an imitation learning process, and a deep learning process. As an example, the vehicle 200 and the track may be in a simulation. In other words, the vehicle 200 and the track may be simulated and part of a driving simulation system 120.

At step 520, the control module 420 may cause the processor(s) 310 to determine a current state of the vehicle 200 along the track. As previously mentioned, the current state of the vehicle 200 along the track may include a location of the vehicle 200 along the track, proximity of the vehicle 200 to surrounding objects, an orientation of the vehicle 200, and/or a speed of the vehicle 200. The control module 420 may determine the current state of the vehicle 200 by requesting and receiving information from sensors 320 and/or various vehicle systems 340 such as accelerometers.

At step 530, the control module 420 may cause the processor(s) 310 to output eye direction instruction for a user of the vehicle 200 based on the driving model 450 and the current state of the vehicle 200. As previously mentioned, and as an example, the control module 420 may output eye direction instruction by highlighting a portion 130 of a display screen 110 for the user to direct the user's eyes. The display screen 110 outputs a view of the environment visible to the user through a window of the vehicle 200. As previously mentioned, and as another example, the control module 420 may output eye direction instruction by highlighting a portion 230 of a window 210 of the vehicle 200 for the user to direct the user's eyes.

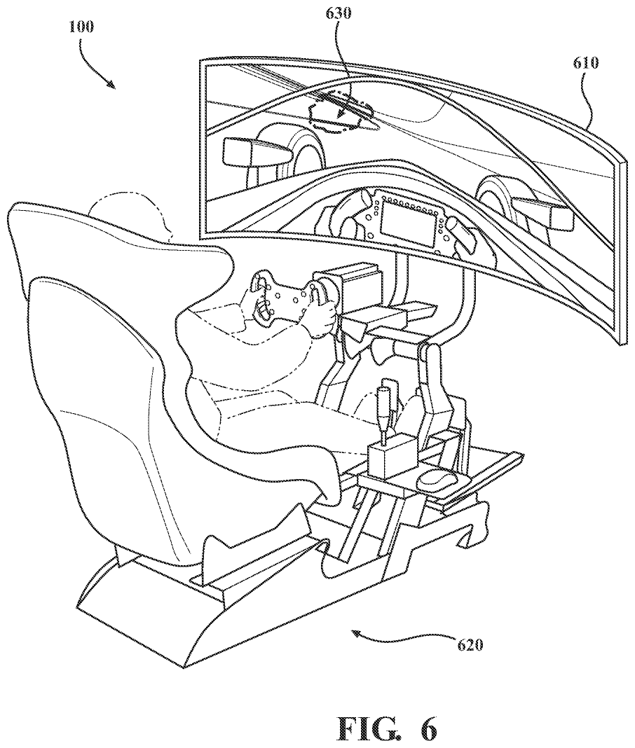

A non-limiting example of the operation of the VFO system 100 and/or one or more of the methods will now be described in relation to FIG. 6. FIG. 6 shows an example of assisting a user of a vehicle driving the vehicle along a track.

As shown in FIG. 6, the user is using a driving simulation system 620. The driving simulation system 620 includes the VFO system 100. The driving simulation system 620 includes a display screen 610. The display screen 610 outputs an image of a simulated environment. The VFO system 100 or, more specifically, the control module 420 predicts a location 630 that an expert driver's eyes may focus on in the simulated environment based on the driving model(s) 450 and the current state of the vehicle 200, as previously discussed. The control module 420 may then cause the location 630 to be highlighted as shown.

FIG. 3 will now be discussed in full detail as an example environment within which the system and methods disclosed herein may operate. In some instances, the vehicle 200 is configured to switch selectively between one or more semi-autonomous operational modes and/or a manual mode. Such switching can be implemented in a suitable manner, now known, or later developed. “Manual mode” means that all of or a majority of the navigation and/or maneuvering of the vehicle 200 is performed according to inputs received from a user (e.g., human driver). In one or more arrangements, the vehicle 200 can be a conventional vehicle that is configured to operate in only a manual mode.

In one embodiment, the vehicle 200 is configured with one or more semi-autonomous operational modes in which one or more computing systems perform a portion of the navigation and/or maneuvering of the vehicle 200 along a track, and a user (i.e., driver) provides inputs to the vehicle 200 to perform a portion of the navigation and/or maneuvering of the vehicle 200 along the track.

The vehicle 200 can include one or more processors 310. In one or more arrangements, the processor(s) 310 can be a main processor of the vehicle 200. For instance, the processor(s) 310 can be an electronic control unit (ECU). As previously mentioned, the processor(s) 310 may be a part of the VFO system 100, or the VFO system 100 may access the processor(s) 310 through a data bus or another communication pathway.

The vehicle 200 can include one or more data stores 315 for storing one or more types of data. The data store 315 can include volatile and/or non-volatile memory. Examples of suitable data stores 315 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 315 can be a component of the processor(s) 310, or the data store 315 can be operatively connected to the processor(s) 310 for use thereby. The term ““operatively connected”,” as used throughout this description, can include direct or indirect connections, including connections without direct physical contact.

The one or more data stores 315 can include sensor data 316. In this context, “sensor data” means any information about the sensors that the vehicle 200 is equipped with, including the capabilities and other information about such sensors. As will be explained below, the vehicle 200 can include the sensor system 320. The sensor data 316 can relate to one or more sensors of the sensor system 320. As an example, in one or more arrangements, the sensor data 316 can include information on one or more vehicle sensors 321 and/or environment sensors 322 of the sensor system 320.

In some instances, at least a portion of the sensor data 316 can be located in one or more data stores 315 located onboard the vehicle 200. Alternatively, or in addition, at least a portion of the sensor data 316 can be located in one or more data stores 315 that are located remotely from the vehicle 200.

As noted above, the vehicle 200 can include the sensor system 320. The sensor system 320 can include one or more sensors. “Sensor” means any device, component and/or system that can detect, and/or sense something. The one or more sensors can be configured to detect, and/or sense in real-time. As used herein, the term ““real-time”” means a level of processing responsiveness that a user or system senses as sufficiently immediate for a particular process or determination to be made, or that enables the processor 310 to keep up with some external process.

In arrangements in which the sensor system 320 includes a plurality of sensors, the sensors can work independently from each other. Alternatively, two or more of the sensors can work in combination with each other. In such a case, the two or more sensors can form a sensor network. The sensor system 320 and/or the one or more sensors can be operatively connected to the processor(s) 310, the data store(s) 315, and/or another element of the vehicle 200 (including any of the elements shown in FIG. 3). The sensor system 320 can acquire data of at least a portion of the internal environment (e.g., inside the vehicle cabin) as well as the external environment of the vehicle 200 (e.g., the track, nearby vehicles, pedestrians, objects).

The sensor system 320 can include any suitable type of sensor. Various examples of different types of sensors will be described herein. However, it will be understood that the embodiments are not limited to the particular sensors described. The sensor system 320 can include one or more vehicle sensors 321. The vehicle sensor(s) 321 can detect, determine, and/or sense information about the vehicle 200 itself. In one or more arrangements, the vehicle sensor(s) 321 can be configured to detect, and/or sense position and orientation changes of the vehicle 200, such as, for example, based on inertial acceleration. In one or more arrangements, the vehicle sensor(s) 321 can include one or more accelerometers, one or more gyroscopes, an inertial measurement unit (EIU), a dead-reckoning system, a global navigation satellite system (GNSS), a global positioning system (GPS), a navigation system 347, and/or other suitable sensors. The vehicle sensor(s) 321 can be configured to detect, and/or sense one or more characteristics of the vehicle 200. In one or more arrangements, the vehicle sensor(s) 321 can include a speedometer to determine a current speed of the vehicle 200.

Various examples of sensors of the sensor system 320 will be described herein. The example sensors may be part of the one or more environment sensors 322 and/or the one or more vehicle sensors 321. However, it will be understood that the embodiments are not limited to the particular sensors described.

As an example, in one or more arrangements, the sensor system 320 can include one or more radar sensors 323, one or more LIDAR sensors 324, one or more sonar sensors 325, and/or one or more cameras 326. In one or more arrangements, the one or more cameras 326 can be high dynamic range (HDR) cameras or infrared (IR) cameras. Any sensor in the sensor system 320 that is suitable for detecting and observing humans, human heads, and/or human eyes can be used inside the vehicle 200 to observe the user, the user's head position, and the user's eyes.

The vehicle 200 can include an input system 330. An “input system” includes any device, component, system, element or arrangement or groups thereof that enable information/data to be entered into a machine. The input system 330 can receive an input from a user (e.g., a driver, an operator, or a passenger). The vehicle 200 can include an output system 335. An “output system” includes any device, component, or arrangement or groups thereof that enable information/data to be presented to a user (e.g., a person, an operator, or a vehicle passenger) such as a display screen or a vehicle window that is capable of outputting information on its surface.

The vehicle 200 can include one or more vehicle systems 340. Various examples of the one or more vehicle systems 340 are shown in FIG. 3. However, the vehicle 200 can include more, fewer, or different vehicle systems 340. It should be appreciated that although particular vehicle systems are separately defined, each or any of the systems or portions thereof may be otherwise combined or segregated via hardware and/or software within the vehicle 200. The vehicle 200 can include a propulsion system 341, a braking system 342, a steering system 343, throttle system 344, a transmission system 345, a signaling system 346, and/or a navigation system 347. Each of these systems can include one or more devices, components, and/or a combination thereof, now known or later developed.

The navigation system 347 can include one or more devices, applications, and/or combinations thereof, now known or later developed, configured to determine the geographic location of the vehicle 200 and/or to determine a track for the vehicle 200. The navigation system 347 can include one or more mapping applications to determine a track for the vehicle 200. The navigation system 347 can include a global positioning system, a local positioning system or a geolocation system.

The processor(s) 310 and/or the VFO system 100 can be operatively connected to communicate with the various vehicle systems 340 and/or individual components thereof. For example, the processor(s) 310 and/or the VFO system 100 can be in communication to send and/or receive information from the various vehicle systems 340 to control the movement, speed, maneuvering, heading, direction, etc. of the vehicle 200. The processor(s) 310 and/or VFO system 100 may control some or all of these vehicle systems 340 and, thus, may be partially autonomous.

The processor(s) 310 and/or the VFO system 100 may be operable to control the navigation and/or maneuvering of the vehicle 200 by controlling one or more of the vehicle systems 340 and/or components thereof. As an example, the processor(s) 310 and VFO system 100 can activate, deactivate, and/or adjust the parameters (or settings) of the one or more driver assistance systems. The processor(s) 310 and/or VFO system 100 can cause the vehicle 200 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 200 can include one or more actuators 350. The actuators 350 can be any element or combination of elements operable to modify, adjust and/or alter one or more of the vehicle systems 340 or components thereof to responsive to receiving signals or other inputs from the processor(s) 310. Any suitable actuator can be used. For instance, the one or more actuators 350 can include motors, pneumatic actuators, hydraulic pistons, relays, solenoids, and/or piezoelectric actuators, just to name a few possibilities.

The vehicle 200 can include one or more modules, at least some of which are described herein. The modules can be implemented as computer-readable program code that, when executed by a processor 310, implements one or more of the various processes described herein. One or more of the modules can be a component of the processor(s) 310, or one or more of the modules can be executed on and/or distributed among other processing systems to which the processor(s) 310 is operatively connected. The modules can include instructions (e.g., program logic) executable by one or more processor(s) 310. Alternatively, or in addition, one or more data store 315 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++, or the like and conventional procedural programming languages, such as the “C” programming language or similar programming languages. The program code may execute entirely on the ‘user’s computer, partly on the ‘user’s computer, as a stand-alone software package, partly on the ‘user’s computer and partly on a remote computer, or entirely on the remote computer or server. In the latter scenario, the remote computer may be connected to the ‘user’s computer through any type of network, including a local area network (LAN) or a wide area network (WAN), or the connection may be made to an external computer (for example, through the Internet using an Internet Service Provider).

As used herein, the term “substantially” or “about” includes exactly the term it modifies and slight variations therefrom. Thus, the term “substantially equal” means exactly equal and slight variations therefrom. “Slight variations therefrom” can include within 15 percent/units or less, within 14 percent/units or less, within 13 percent/units or less, within 12 percent/units or less, within 11 percent/units or less, within 10 percent/units or less, within 9 percent/units or less, within 8 percent/units or less, within 7 percent/units or less, within 6 percent/units or less, within 5 percent/units or less, within 4 percent/units or less, within 3 percent/units or less, within 2 percent/units or less, or within 1 percent/unit or less. In some instances, “substantially” can include being within normal manufacturing tolerances.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A method, comprising:
developing a driving model for a vehicle travelling on a track;
determining a current state of the vehicle along the track; and
outputting eye direction instruction for a user of the vehicle based on the driving model and the current state of the vehicle.

2. The method of claim 1, wherein developing the driving model for the vehicle travelling on the track is based on at least one of:
a reinforcement learning process; or
an imitation and deep learning process.

3. The method of claim 1, wherein the vehicle and the track are in a simulation.

4. The method of claim 1, wherein the current state of the vehicle along the track includes at least one of:
a location of the vehicle along the track;
proximity of the vehicle to surrounding objects;
an orientation of the vehicle; or
a speed of the vehicle.

5. The method of claim 1, wherein outputting eye direction instruction includes highlighting a portion of a display screen for the user to face, wherein the display screen outputs a view of an environment visible to the user through a window of the vehicle.

6. The method of claim 1, wherein outputting eye direction instruction includes highlighting a portion of a window of the vehicle for the user to face.

7. The method of claim 1, wherein a goal of the driving model includes at least one of:
shortest completion time for the track;
lowest fuel consumption; or
most suitable racing line.

8. A system, comprising:
a processor; and
a memory storing machine-readable instructions that, when executed by the processor, cause the processor to:
develop a driving model for a vehicle travelling on a track;
determine a current state of the vehicle along the track; and
output eye direction instruction for a user of the vehicle based on the driving model and the current state of the vehicle.

9. The system of claim 8, wherein the machine-readable instructions that, when executed by the processor, cause the processor to develop the driving model for the vehicle travelling on the track are based on at least one of:
a reinforcement learning process; or
an imitation and deep learning process.

10. The system of claim 8, wherein the vehicle and the track are in a simulation.

11. The system of claim 8, wherein the current state of the vehicle along the track includes at least one of:
a location of the vehicle along the track;
proximity of the vehicle to surrounding objects;
an orientation of the vehicle; or
a speed of the vehicle.

12. The system of claim 8, wherein the machine-readable instructions that, when executed by the processor, cause the processor to output eye direction instruction include highlighting a portion of a display screen for the user to face, wherein the display screen outputs a view of an environment visible to the user through a window of the vehicle.

13. The system of claim 8, wherein the machine-readable instructions that, when executed by the processor, cause the processor to output eye direction instruction include highlighting a portion of a window of the vehicle for the user to face.

14. The system of claim 8, wherein a goal of the driving model includes at least one of:
shortest completion time for the track;
lowest fuel consumption; or
most suitable racing line.

15. A non-transitory computer-readable medium including machine-readable instructions that, when executed by a processor, cause the processor to:
develop a driving model for a vehicle travelling on a track;
determine a current state of the vehicle along the track; and
output eye direction instruction for a user of the vehicle based on the driving model and the current state of the vehicle.

16. The non-transitory computer-readable medium of claim 15, wherein the machine-readable instructions that, when executed by the processor, cause the processor to develop the driving model for the vehicle travelling on the track are based on at least one of:
a reinforcement learning process; or
an imitation and deep learning process.

17. The non-transitory computer-readable medium of claim 15, wherein the vehicle and the track are in a simulation.

18. The non-transitory computer-readable medium of claim 15, wherein the current state of the vehicle along the track includes at least one of:
a location of the vehicle along the track;
proximity of the vehicle to surrounding objects;
an orientation of the vehicle; or
a speed of the vehicle.

19. The non-transitory computer-readable medium of claim 15, wherein the machine-readable instructions that, when executed by the processor, cause the processor to output eye direction instruction include highlighting a portion of a display screen for the user to face, wherein the display screen outputs a view of an environment visible to the user through a window of the vehicle.

20. The non-transitory computer-readable medium of claim 15, wherein the machine-readable instructions that, when executed by the processor, cause the processor to output eye direction instruction include highlighting a portion of a window of the vehicle for the user to face.
